(19) United States
(12) Patent Application Publication
(10) Pub. No.: US 2001/0036391 A1
(43) Pub. Date: Nov. 1, 2001

(54) Expansion sleeve for an expansion anchor

(76) Inventors: Werner Kaibach, Buchloe (DE); Stefan Raber, Kaufering (DE); Hans-Jurgen Negele, Denklingen (DE)

Correspondence Address: David Toren, BROWN & WOOD LLP, One World Trade Center, New York, NY, 10048-0557, US

(21) Appl. No.: 09/800,294

(22) Filed: Feb. 12, 2001

Related U.S. Application Data
(63) Continuation-in-part of application No. 09/528,597, filed on Mar. 20, 2000, now abandoned.

(30) Foreign Application Priority Data
Mar. 23, 1999 (DE) 199 13 229.1

(51) Int. Cl. F16B 1/00

(52) U.S. Cl. 411/57.1

(57) ABSTRACT

An expansion sleeve for an expansion anchor and having two axial grooves (7, 9) formed at a rear edge (2) of the sleeve and arranged diametrically opposite each other, and a recess (8, 10) formed in at least one of opposite side walls (3, 5) of a respective groove (7, 9), with the side walls (3, 5) of the two grooves (7, 9), in which respective recesses (8, 10) are formed, being located opposite each other.

### RELATED APPLICATION

This application is a continuation-in-part of application Ser. No. 09/528,597 filed on Mar. 20, 2000.

### BACKGROUND OF THE INVENTION

1. Field of the Invention

The present invention relates to an expansion anchor including an anchor rod having a head portion widening toward the free end of the anchor rod, and an expansion sleeve having an expansion region formed of expansion tabs which expand radially upon displacement of the expansion sleeve over the head portion of the anchor rod. In particular, the present invention relates to an expansion sleeve for the expansion anchor and having a substantially cylindrical body and two axial grooves formed at a rear edge of the cylindrical body and arranged diametrically opposite each other.

2. Description of the Prior Art

As discussed above, an anchor of the type described above has an anchor rod with a head portion that widens to the free end of the anchor rod, so that upon driving of the expansion sleeve along a widening, substantially conical head portion, the expansion tabs expand radially. Such an expansion anchor is described, e.g., in U.S. Pat. No. 4,702,654. The expansion anchor disclosed in the above-mentioned U.S. patent is formed as an undercut self-cutting anchor that forms, upon being anchored, an undercut in the wall of a bore and is formlockingly anchored in the bore. The expansion sleeve is rotatably driven over the conical head of the anchor rod. Upon displacement of the expansion sleeve over the conical head of the anchor rod, the cutters, which are provided at the free ends of the expansion tabs form, by milling and shaving, an undercut in the bore wall. For transmitting a rotational movement to the expansion sleeve, the sleeve, as discussed above, is provided with two axial grooves at its rear end which are arranged diametrically opposite each other. The grooves are shaped for an engagement with a correspondingly formed setting tool which is percussion rotary driven, e.g., by a hammer drill, so that in addition to being axially driven, the sleeve is also rotatably driven.

The known expansion anchor, after having been anchored in a bore, as a rule, cannot be extracted from the bore. With known expansion anchors and, in particular, with undercut self-cutting anchors, there exists a possibility that the anchor cannot be completely set in the bore. E.g., if upon setting, a conventional anchor encounters a reinforcing metal, the metal, as a rule, prevents a complete expansion of the expansion tabs. However, even if the anchor has expanded only to a very small degree, it cannot be extracted any from a bore by hand. Because the anchor did not completely expand, the attachment point cannot be used. Also, an inspection of an attachment point can require that an anchor be extracted. With the conventional anchors, it is hardly possible and, in case when necessary, can be done only with very high expenses. Also, a complete dismounting may be needed. I.e., after an attachment point is completed, it should be completely dismount. As discussed above, with conventional anchors, this is not possible or only possible with very high expenditures.

Accordingly, an object of the present invention is to eliminate the drawbacks of conventional expansion anchors by providing an expansion anchor which, when necessary, can be relatively easily dismounted.

Another object of the present invention is to provide an expansion anchor that can be relatively easily dismounted and, at the same time, be produced in a simple and cost-effective way.

### SUMMARY OF THE INVENTION

These and other objects of the present invention, which will become apparent hereinafter, are achieved by providing an expansion sleeve for an expansion anchor of the type described above and having a substantially cylindrical body, two axial grooves formed at a rear edge of the cylindrical body and arranged diametrically opposite each other, and a recess formed in at least one of opposite side walls of respective grooves, with the side walls of the two grooves, in which respective recesses are formed, being located opposite each other.

The axial grooves serve, as discussed above, for the transmission of the rotational movement to the sleeve. The recesses in the side walls of the grooves are formed for engagement with radially projecting pegs of a dismounting tool. Because the recesses are formed in the opposite walls of the two grooves, the dismounting tool can be easily axially inserted into the grooves and pivoted so that the radially projecting pegs engage in the recesses which are arranged, as discussed above, diametrically opposite each other. Upon engagement of the radially projecting pegs in respective recesses, the dismounting tool becomes formlockingly connected with the expansion sleeve and cannot be pulled out of the groove, so that when a pulling force is applied to the dismounting tool, it is pulled out together with expansion sleeve, extracting the expansion sleeve from the bore.

In order to provide for an adequate axial engagement of the dismounting tool with the expansion sleeve, advantageously the circumferential extension of each recess amounts to from about 20% to about 100% of the groove width, preferably, from about 40% to about 70%. The foregoing dimension of the recesses prevents the pegs of the dismounting tool from sliding out of the recesses upon axial pulling of the dismounting tool.

In order to be able to apply relatively high pulling forces, which are often necessary at dismounting, without a danger to an operator, advantageously a material web of the side wall of the groove, in which a recess is formed, has an axial thickness amounting to at least 20% of the axial depth of the groove. With such material web, a danger of rupture of the material is prevented.

The recess can have any arbitrary shape. For manufacturing reason, the side recess has a shape of a substantially circular excursion, preferably, the shape of a semicircle. Such a recess can be formed in a simple and cost-effective way, e.g., by transverse drilling of the sleeve. The radius of the curvature of the recess corresponds to from about 0.1 time to about 0.5 time, preferably, from 0.2 time to 0.4 time of the axial depth of the groove.

To facilitate insertion of the dismounting tool, the recesses can be formed in both side walls of a groove.

While the provision of the recesses in the side walls of the grooves of an expansion sleeve proved to be advantageous for dismounting of all types of expansion anchors, if proved particularly advantageous for the undercut self-cutting expansion anchors.

The novel features of the present invention, which are considered as characteristic for the invention, are set forth in particular in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS:

FIG. 1 an axial cross-sectional view of an expansion anchor with an expansion sleeve according to the present invention;

FIG. 2 a perspective view of the expansion sleeve according to the present invention;

FIG. 3 a side view of an expansion sleeve dismounting tool;

FIG. 4 a cross-sectional view of the tool shown in FIG. 3;

FIG. 5 a cross-sectional view of the expansion anchor shown in FIG. 1 inserted in a bore of a constructional component, with a dismounting tool being spaced from the anchor; and

FIG. 6 a cross-sectional view similar to that of FIG. 5 but with the dismounting tool engaging the expansion sleeve.

### DETAILED DESCRIPTION OF THE PREFERRED EMBODIMENT

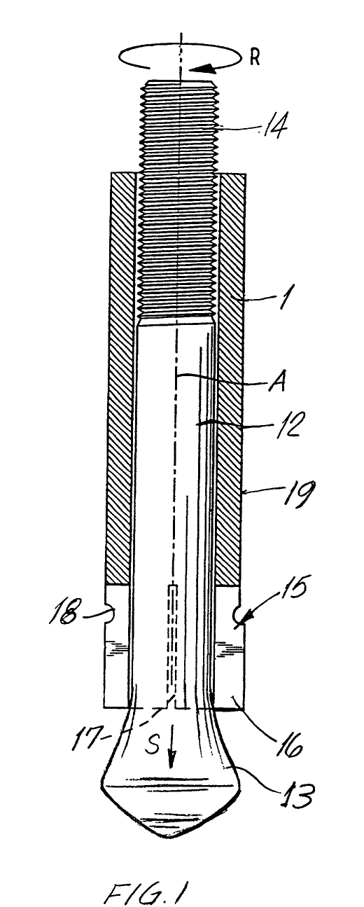

FIG. 1 shows an expansion anchor with an expansion sleeve 1 according to the present invention. The expansion anchor includes an anchor rod 12 having a head portion 13 which widens in a setting direction S. The head portion 13 is formed with a concave outer surface. However, the head portion 13 can be formed as a cone stub. The end portion of the anchor rod 12 opposite the head portion 13 is provided with an outer thread 14 which functions as load-application means. The expansion sleeve 1 has, at its end adjacent to the head portion 13, an expansion region 15 formed of a plurality of expansion tabs 16 separated from each other by axially extending slots 17. The expansion region 15 is separated from the remaining portion of the sleeve 1 by a flexible hinge 18. The flexible hinge 18 can be formed, as shown in FIG. 1, as a circumferential groove provided in the outer surface 19 of the sleeve 1. To form an undercut in a cylindrical bore of a constructional component, appropriate cutters (not shown) are provided in the free end regions of the expansion tabs 16. Upon displacement of the sleeve 1 over the anchor rod 12, with the expansion tabs 16 being displaced over the head portion 13 of the anchor rod 12, the expansion tabs 16 expand, with the cutters, which are provided at free ends of the expansion tabs 16, forming an undercut in a known manner. The sleeve 1 is displaced over the anchor rod 12, e.g., by a hammer drill that imparts to the sleeve 1 both translational and rotational movement in per se known manner.

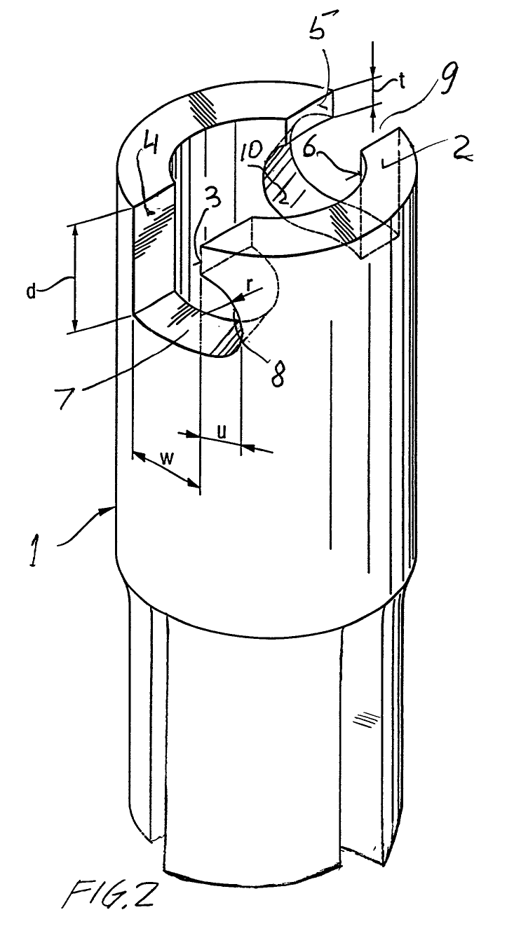

FIG. 2 shows a perspective view of the expansion sleeve 1 according to the present invention. Two grooves 7 and 9 extend from a rear edge of the expansion sleeve 1 in an axial direction. The grooves 7 and 9 are located diagonally opposite each other. The axially extending grooves 7 and 9 are limited by side walls 3, 4 and 5, 6, respectively.

In a respective side wall 3, 5 of a respective groove 7, 9, there is provided a recess 8, 10, respectively. The recesses 8, 10 are formed in the oppositely arranged surfaces 3 and 5 of the two grooves 7 and 9. Advantageously, the recesses 8 and 10 have a shape of a circular excursion. In this way, the excursion-shaped recesses 8 and 10 can be easily formed by transverse boring of the sleeve 1. The radius of the curvature r of the curved recesses 8 and 10 amounts to from 0.1 to 0.5 times of the axial depth of the grooves 7 and 9. In a preferred embodiment of the present invention, the radius r of the recesses 8 and 10 corresponds to about 0.2 to 0.4 times of the axial depth of the grooves 8 and 10. The extension u of the grooves 7 and 9 in the circumferential direction amounts to from about 20% to about 100%, preferably, from about 40% to about 70% of the width w of the grooves 7 and 9. The ratio of the width w of the grooves 7 and 9 to their depth d is 0.2≦w/d≦1.5, preferably, 0.5≦w/d≦1.2. The material web of the opposite walls 3 and 5 of the two grooves 7 and 9, which is defined by respective arcuate recesses 8 and 10, has a thickness t that amounts at least to 20% of the axial depth d of the grooves 7 and 9.

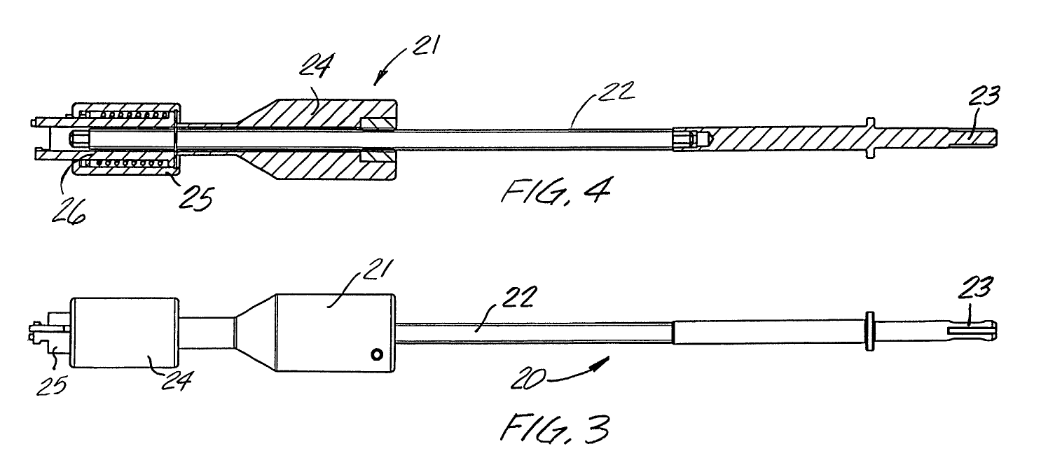

The provision, according to the present invention, of the side recesses 8 and 10 in the grooves 7 and 9 at the rear edge of the expansion sleeve 1 is particularly advantageous for anchors to be set in bores having and undercut, as it permits to anchor such expansion anchor with percussion rotary tools. The advantages of forming recesses in side walls of axial grooves at the rear edge of the expansion sleeve are most apparent in undercut self-cutting anchors with which, during a setting process, the cutters, which are provided on the expansion tabs 16 of the expansion sleeve 1, form an undercut in a wall of a bore, in which an expansion anchor is being set, by milling and shaving the wall. The grooves 7 and 9 are designed for cooperation with a conventional setting tool. The setting tool has a pair of claws which project from an end surface of the tool and engage in the grooves 7 and 9 for transmitting the rotational movement of the setting tool to the expansion sleeve 1. For dismounting of the expansion anchors with an expansion sleeve according to the present invention, a dismounting tool 20, which is shown in FIGS. 3-4, is used.

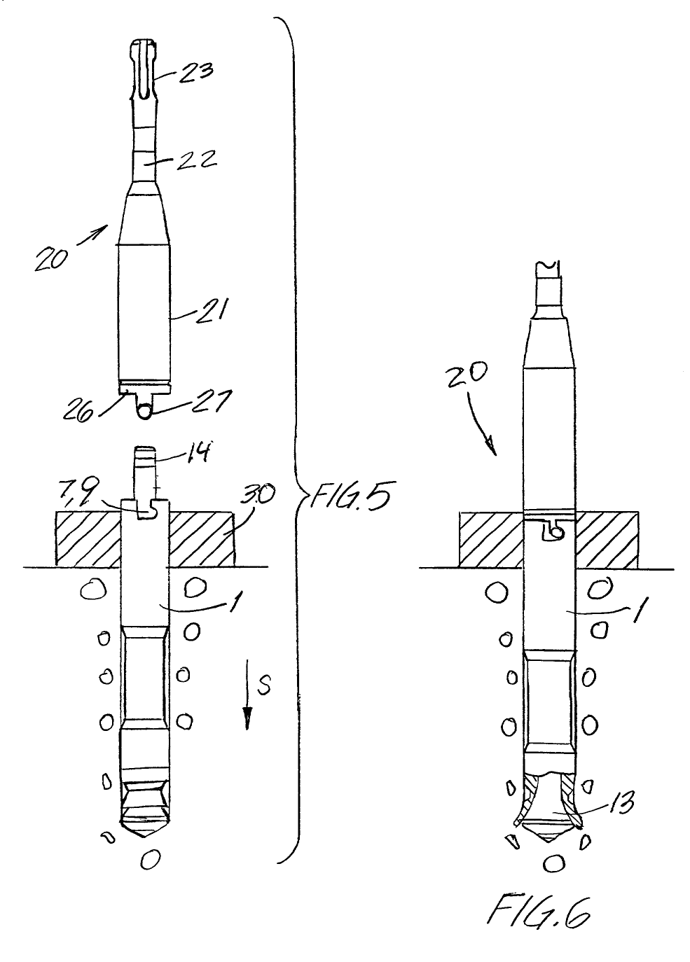

The dismounting tool 20 has a head 21, a stem 22 and a shank 23 which is provided at the tool end opposite the head 21 and is received in a chuck, e.g., of a drilling tool. The head 21 has a body 24 fixedly secured to the stem 22 and a sleeve-shaped end member 25 fixedly secured to the body 24. A sleeve-shaped engagement member 26 is secured in the sleeve-shaped end member 25. The engagement member 26 projects beyond the free end surface of end member 25 by a distance corresponding to the sum of the length by which the anchor rod 12 projects above the rear end surface of the sleeve 1 and the depth d of the grooves 7 and 9 of the expansion sleeve 1. At the free end of the engagement member 26, there are provided two pegs 27 which project radially at the front end of the tool. The pegs 27 are advanced into engagement with the diametrically opposite grooves 7 and 9 of the sleeve 1. Upon rotation of the dismounting tool 20 about its longitudinal axis, the radially projecting pegs 27 become engaged in the recesses 8 and 10 formed in the opposite side walls 3 and of the grooves 7 and 9, respectively. The expansion sleeve 1 is pulled out of the bore by application of a pulling force to the dismounting tool 20. Then, the expansion anchor rod is pulled out. The position of the dismounting tool 20 before and after the engagement with the sleeve 1 is shown in FIGS. 5-6 which show the use of an expansion anchor for securing a constructional part 30 to a constructional component A.

Though the present invention was shown and described with references to the preferred embodiments, such are merely illustrative of the present invention and are not to be construed as a limitation thereof and various modifications of the present invention will be apparent to those skilled in the art. It is therefore not intended that the present invention be limited to the disclosed embodiments or details thereof, and the present invention includes all variations and/or alternative embodiments within the spirit and scope of the present invention as defined by the appended claims.

What is claimed is:

1. An expansion sleeve for an expansion anchor, comprising a substantially cylindrical body; two axial grooves (7,9) formed at a rear edge (2) of the cylindrical body and arranged diametrically opposite each other; and a recess (8, 10) formed in at least one of opposite side walls (3, 5) of a respective groove (7, 9), with the side walls (3, 5) of the two grooves (7, 9), in which respective recesses (8, 10) are formed, being located opposite each other.

2. An expansion sleeve according to claim 1, wherein a circumferential extension (u) of each of the recesses (8, 9) amounts to from about 20% to about 100% of a width (w) of the groove (7, 9).

3. An expansion sleeve according to claim 2, wherein the circumferential extension (u) of each of the recesses (8, 10) amounts to from about 40% to about 70% of a width (w) of the groove (7, 9).

4. An expansion sleeve according to claim 1, wherein a material web of the side wall (3, 5), in which the recess (8, 10) is formed, has an axial thickness (t) amounting to at least 20% of an axial depth (d) of the groove (7, 9).

5. An expansion sleeve according to claim 1, wherein the side recesses (8, 10) have a shape of a substantially circular excursion having a radius of curvature corresponding to from about 0.1 time to about 0.5 time of an axial depth (d) of the groove (7, 9).

6. An expansion sleeve according to claim 5, wherein the side recesses (8, 10) have a shape of a semi-circle with the radius of curvature corresponding to from about 0.2 time to about 0.4 time of the axial depth (d) of the groove (7, 9).

7. An expansion sleeve according to claim 1, wherein a recess is provided in each of the opposite side walls of each groove (7, 9).
